(19) United States
(12) Patent Application Publication
(10) Pub. No.: US 2007/0157585 A1
(43) Pub. Date: Jul. 12, 2007

(54) Automatic air purifying windows

(76) Inventor: Byung-su Lee, Gangwon-do (KR)

Correspondence Address: CANTOR COLBURN, LLP, 55 GRIFFIN ROAD SOUTH, BLOOMFIELD, CT, 06002, US

(21) Appl. No.: 10/577,596

(22) PCT Filed: Oct. 26, 2004
(86) PCT No.: PCT/KR04/02725

§ 371 Date: Apr. 26, 2006

(30) Foreign Application Priority Data
Oct. 29, 2003 (KR) 10-2003-0076071

(51) Int. Cl. B01D 50/00

(52) U.S. Cl. 55/385.1

(57) ABSTRACT

An automatic air-purifying window automatically purifies polluted indoor air while exhibiting general inherent functions of the window. The automatic air-purifying window comprises a window and a window stile for fixing the window. The window stile comprises a discharge part, an induction part, and an indoor air circulation passageway. The discharge part includes an indoor air induction port, an upper guide member to guide air current induced from the indoor air induction port, and an indoor air discharge port to discharge some portion of the indoor air from the indoor air induction port to the outside. The induction part includes an outdoor air induction port, a lower guide member to guide air current induced from the outdoor air induction port, a purification cartridge, a light-transmission portion, and a purified air discharge port. With such a construction, polluted air within the room can be not only automatically purified, but also discharged to the outside without opening the window while purifying air induced from the outside, thereby maintaining fresh indoor air.

### TECHNICAL FIELD

The present invention relates to windows available to buildings, and, more particularly, to automatic air purifying windows designed to automatically purify polluted indoor air while exhibiting general inherent functions of the windows for separating a room from the outside, and to allow some portion of polluted indoor air to be discharged to the outside without opening the windows while allowing outdoor air to be induced from the outside in a purified state, thereby maintaining fresh and clean indoor air.

### BACKGROUND ART

Conventionally, glass windows are generally equipped to various buildings, such as public buildings, workplaces, office buildings, common houses, for the purpose of creating pleasant indoor environments by ensuring visibility of a person in a living space to the outside, a sufficient amount of sunlight exposure, thermal insulation, soundproofing, and prevention of outside pollutants from being induced into a room.

Installation of the conventionally available windows is shown in FIG. 1. As shown in FIG. 1, a conventional window comprises a sheet of glass 200, and a rectangular window stile 100 for holding the sheet of glass 200 therein, and the window can be slidably equipped in a window frame 300.

The window stile 100 comprises an upper window stile 110 and a lower window stile 120, which are respectively formed at an upper surface and a lower surface thereof with guide grooves (not shown), thereby allowing the window to be slidably opened or closed in the longitudinal direction by virtue of cooperation with guides (not shown) provided to the window frame 300. As such, windows are installed such that the windows can be opened or closed in the frame, thereby allowing ventilation of the room by opening/closing the windows.

In order to create a pleasant indoor environment, it is desired that the windows should be opened at predetermined time intervals for ventilation. Particularly, indoor air is apt to be easily polluted due to gases combusted during cooking in the kitchen or detrimental substances resulting from various construction materials and electronic devices. As such polluted air is constantly accumulated in the room, the health of the inhabitants may be deteriorated, and various diseases can be caused. Accordingly, in order to prevent indoor air from being polluted, periodical ventilation of the room is required.

However, in such a window construction as described above, there are problems in that, as air pollution and traffic noise have become severe due to rapid industrialization, everyday life depending on vehicles, cityward concentration of populations, and the like, when the windows are opened for the purpose of ventilation, outside pollutants can be induced into an indoor living space, making it difficult to maintain a pleasant indoor environment, thereby not only deteriorating the health of inhabitants, but also reducing the inhabitants' quality of life.

Due to the problems as described above, air cleaning apparatuses have been increasingly available for the purpose of reduction in the pollutants generated in the indoor environment without opening the windows, as well as promotion of inhabitants' health. The air cleaning apparatuses are adapted to maintain a pleasant indoor environment in such a manner that the air cleaning apparatuses filter air induced into the air cleaning apparatuses, and discharge it to the outside thereof.

However, since most of the air cleaning apparatuses currently on the market employ an air purification technology for particulate substances, such as dust or smoke, there are problems not only in that there is a limitation in reduction of indoor pollutants, but also in that it is impossible to continuously supply fresh air from the outdoor by means of natural ventilation because the indoor air is repetitiously purified and then supplied to the room.

In order to solve these problems, various technologies for allowing supply of fresh air by means of natural ventilation have been disclosed, and among the technologies, Korean Utility Model Registration No. 201448 discloses a window-mounted air filter, which can be mounted in a window stile or in an air vent of buildings. The winds mounted air filter is mounted in the window stile or in the air vent of the building, and prevents polluted air from being induced into the room.

### DISCLOSURE OF INVENTION

### Technical Problem

However, when such a window-mounted air filter is employed in a state of being mounted in the window frame or in the air vent, there are problems in that it is difficult to exchange and manage the filter, and in that the window cannot sufficiently exhibit functions, such as the visibility from the living space, the provision of sunlight exposure, and the like.

### TECHNICAL SOLUTION

The present invention has been made to solve the above problems, and it is an object of the present invention to provide an automatic air purifying window, designed to automatically purify polluted indoor air while exhibiting general inherent functions thereof, and to allow some portion of polluted indoor air to be discharged to the outside without opening the window while allowing outdoor air to be induced from the outside in a purified state, thereby maintaining fresh and clean indoor air.

In accordance with an aspect of the present invention, the above and other objects can be accomplished by the provision of an automatic air purifying window, comprising a sheet of glass and a window stile for holding the sheet of glass, wherein the window stile comprises: a discharge part including an indoor air induction port to induce indoor air through a filter attached to a front side of an upper window stile, an upper guide member to guide air current induced from the indoor air induction port, and an indoor air discharge port to discharge some portion of the indoor air induced from the indoor air induction port to the outside through a filter attached to an upper portion of a rear side of a side window stile along a discharge passageway inside the upper guide member; an induction part including an outdoor air induction port to induce outdoor air through a filter attached to a lower portion of the rear side of the side window stile, a lower guide member to guide air current induced from the outdoor air induction port, a purification cartridge embedded at an inner portion of a lower window stile to purify air, flowing along a fluid passageway formed inside the lower guide member and passing through the purification cartridge, a light-transmission portion formed at a rear side of the lower window stile such that light can arrive at the purification cartridge within the lower window stile, and a purified air discharge port adapted to be opened/closed to the front of the lower window stile for allowing exchange of the purification cartridge and to allow the purified air passing through the purification cartridge to be induced into the room through a filter attached to the center of the purified air discharge port; and an indoor air circulation passageway formed in the window stile such that some portion of air induced through the indoor air induction port can be induced into the room after passing through the purification cartridge and the purified air discharge port along the indoor air circulation passageway.

### DESCRIPTION OF DRAWINGS

The foregoing and other objects and features of the present invention will be more clearly understood from the following detailed description taken in conjunction with the accompanying drawings, in which:

FIG. 1 is a diagrammatic view illustrating an installation state of a conventional window;

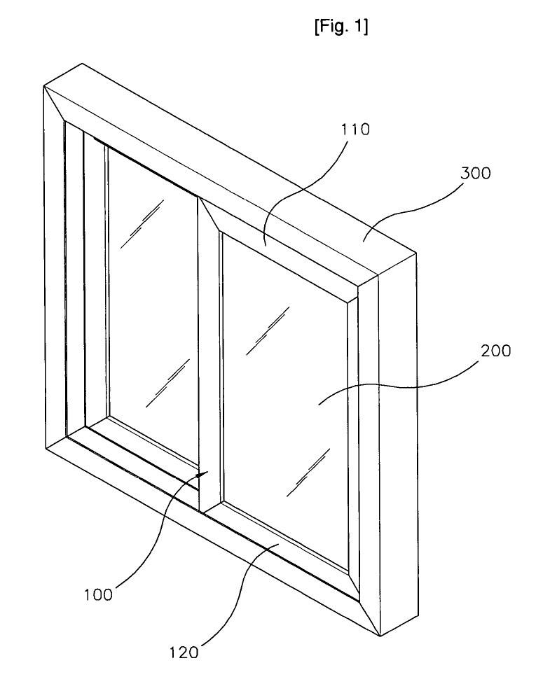

FIG. 2 is a perspective view of a window in accordance with the present invention;

FIG. 3 is a rear perspective view of the window shown in FIG. 2;

FIG. 4 is a partial cross-sectional view of the window in accordance with the present invention;

FIG. 5 is a cross-sectional view of main components of the window in accordance with the present invention in a state of being equipped to a window frame; and

FIG. 6 is an exploded perspective view of a purification cartridge embedded in the window in accordance with the present invention.

### BEST MODE

Preferred embodiments will now be described in detail with reference to the accompanying drawings. It should be understood that the embodiments are illustrated for better understanding of the present invention, and do not restrict the present invention.

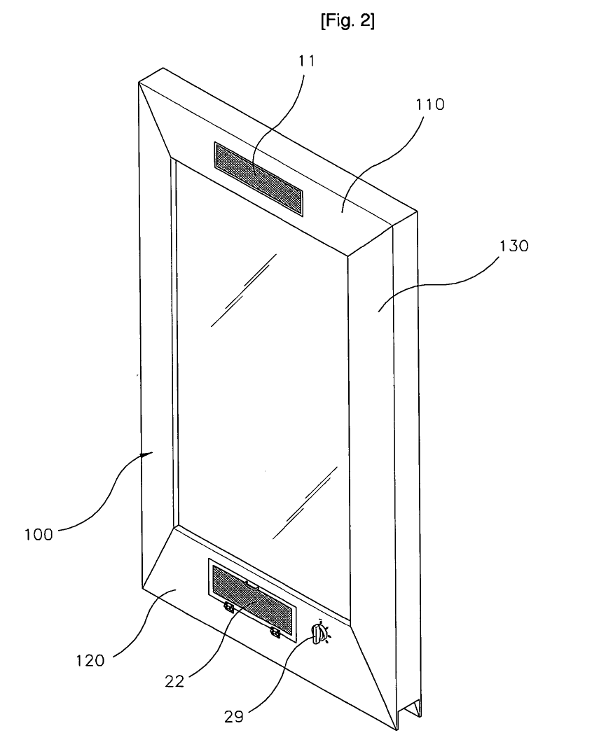

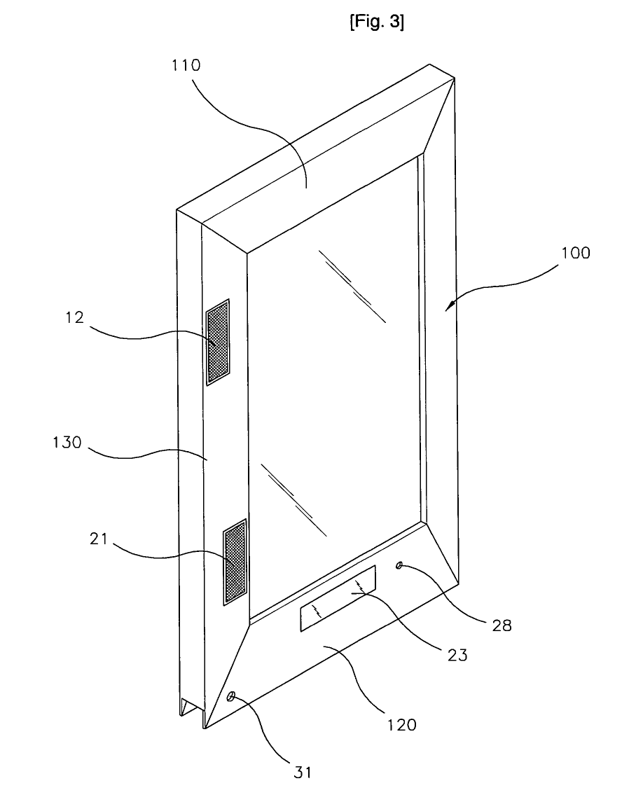

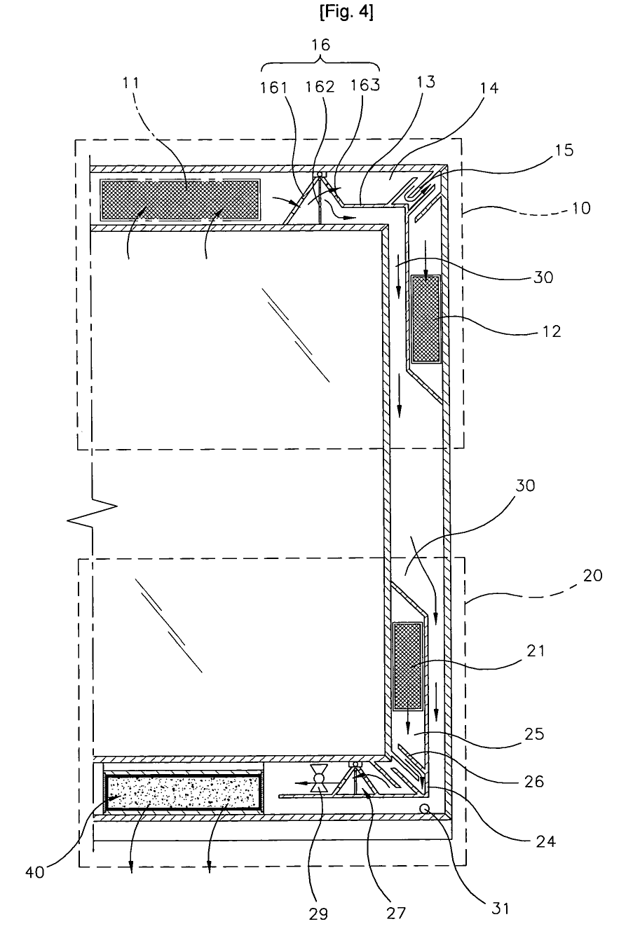

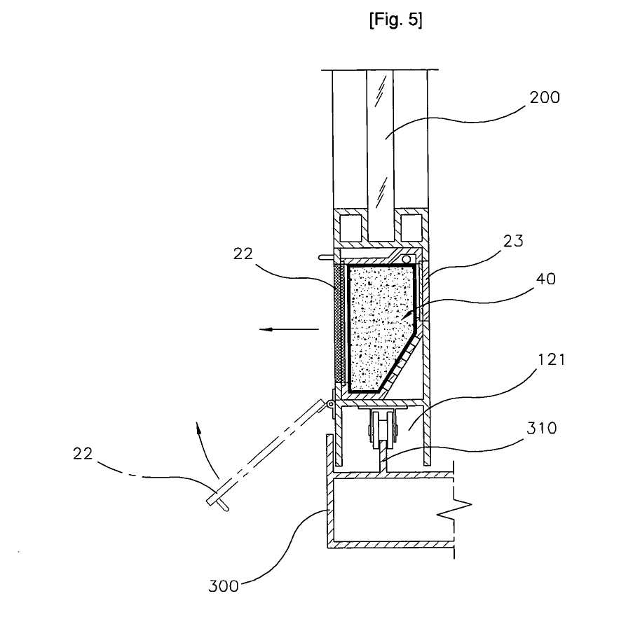

FIG. 2 is a perspective view of a window in accordance with the present invention, FIG. 3 is a rear perspective view of the window shown in FIG. 2, FIG. 4 is a partial cross-sectional view of the window in accordance with the present invention, FIG. 5 is a cross-sectional view of main components of the window of the present invention in a state of being equipped to a window frame.

As shown in FIGS. 2 to 5, the window according to the present invention comprises a sheet of glass 200, and a window stile 100 adapted to hold the sheet of glass 200. The window stile 100 of the present invention allows discharge of indoor air and induction of outdoor air, while allowing circulation of the indoor air. That is, the window of the present invention is characterized in that the window stile 100 as a common component of a typical window is formed with a discharge part 10 to discharge indoor air to the outside, an induction part 20 to induce outdoor air into a room while purifying the outdoor air in order to allow ventilation of the room, and an indoor air circulation passageway 30 to allow the indoor air to be purified while being circulated in the window stile 100.

According to the present invention, when constituting the discharge part 10, the induction part 20, and the indoor air circulation passageway 30 in the window stile 100, the convection phenomenon of indoor air is applied to the present invention in such a manner that some portion of hot air within the room can be discharged to the outside through the discharge part 10 formed at an upper side of the window stile 100, and other portions of the hot air can be induced into the room after being purified while circulating along the indoor air circulation passageway 30, and that cold air on the outside can be induced into the room through the induction part 20 formed at a lower side of the window stile 100.

The discharge part 10 of the window stile 100 includes an indoor air induction port 11 to induce indoor air through a filter attached to a front side of an upper window stile 110, an upper guide member 13 to guide air current induced from the indoor air induction port 11, and an indoor air discharge port 12 to discharge some portion of the indoor air along a discharge passageway 14 formed along the inside of the upper guide member 13 from the indoor air induction port 11 to the outside through a filter attached to an upper portion of a rear side of a side window stile 130.

In the discharge part 10, indoor air is induced into the upper window stile 110 through the indoor air induction port 11. Some portion of the indoor air flows along the discharge passageway 14 formed along the inside of the upper guide member 13, and is then discharged to the outside through the indoor air discharge port 12 formed at the upper portion of the rear side of a side window stile 130. At this time, other portions of the indoor air induced through the indoor air induction port 11 are discharged again to the room through the indoor air circulation passageway 30 described below, and are then circulated into the window stile 100.

In order to prevent the discharge passageway 14 from being blocked by insects or deleterious particles having a large volume induced into the window stile when indoor air is discharged to the outside of the window stile, as described above, filters are attached to the indoor air induction port 11 and the indoor air discharge port 12, respectively. As for the filters, non-woven fabrics or gauze can be used due to its property of allowing easy passage of air, but the present invention is not limited to thereto, and various kinds of material can also be used as for the filters.

According to the present invention, a plurality of skew plates 15 are formed in the discharge passageway 14 formed along the inside of the upper guide member 13 in order to guide air current along a serpentine path, and act to reduce noise from the outside from being transferred to the room. Accordingly, even though the discharge part 10 is formed in the window stile 100, noise from the outside can be prevented from being transferred to the room by means of the skew plates 15, thereby minimizing suffering caused by the noise.

Furthermore, a check valve 16 is also formed in the discharge passageway 14 formed along the inside of the upper guide member 13, preventing outdoor air from being induced into the room through the indoor air discharge port 12.

Various well-known means can be applied to the check valve 16. In this regard, according to the present invention, the check valve 16 comprises an induction membrane 161, a removable membrane 162, and a discharge membrane 163, as shown in the drawings, each of which is configured such that when the movable membrane 162 closely contacts the discharge membrane 163, an air vent formed through the movable membrane 162 coincides with an air vent formed through the discharge membrane 163, and when the movable membrane 162 closely contacts the induction membrane 161, the air vent formed through the movable membrane 162 coincides with an air vent formed through the induction membrane 161.

That is, when indoor air is induced through the indoor air induction port 11, the movable membrane 162 closely contacts the discharge membrane 163, and at this time, as the air vents are communicated with each other rather than being blocked, the induced air sequentially passes through the induction membrane 161, the movable membrane 162, and the discharge membrane 163. On the contrary, when outdoor air is induced into the window stile 100 through the indoor air discharge port 12, the movable membrane 162 closely contacts the induction membrane 161, and the air vent of the induction membrane 161 is blocked, thereby preventing the outdoor air from being induced into the room.

In addition to the discharge part 10, as described above, for discharging the indoor air to the outdoor, the window stile 100 according to the present invention is provided with the induction part 20 for allowing the indoor air to be induced into the room while being purified.

The induction part 20 includes an outdoor air induction port 21 to induce outdoor air through a filter attached to a lower portion of the rear side of the side window stile 130, a lower guide member 24 to guide air current induced from the outdoor air induction port 21, a purification cartridge 40 embedded in an inner portion of a lower window stile 120 to purify air flowing along a fluid passageway 25 formed along the inside of the lower guide member 24 while passing through the purification cartridge 40, a light-transmission portion 23 formed at the rear side of the lower window stile 120 such that light can reach the purification cartridge 40, and a purified air discharge port 22 adapted to be opened/closed to the front of the lower window stile 120 for allowing exchange of the purification cartridge 40, and to allow the purified air passing through the purification cartridge 40 to be induced into the room through a filter attached to the center of the purified air discharge port 22.

With the induction part 20 as described above, outdoor air is induced into the window stile 100 through the outdoor air induction port 21, and flows along the fluid passageway 25 formed along the inside of the lower guide member 24. Then, the outdoor air is purified while passing through the purification cartridge 40, and is then induced into the room through the purified air discharge port 22.

At this time, as the outdoor air passes through the purification cartridge 40, moisture or detrimental substances contained in the outdoor air are adsorbed onto activated carbon embedded in the purification cartridge 40, and are removed through decomposition by means of a photocatalyst. Then, purified air is induced into the room after passing through the purified air discharge port 22. Construction and operation of the purification cartridge 40 will be described in detail hereinafter.

According to the present invention, in order to allow the purification cartridge 40 to be replaced with a new one, the purified air discharge port 22 is attached to the lower window stile 120 such that it can be opened or closed in the front direction of the lower window stile 120. In the drawings, as an opening/closing means, a hinge is used for coupling the purified air discharge port 22 to the lower window stile 120 such that the purified air discharge port 22 can be opened or closed in the front direction of the lower window stile 120, but the present invention is not limited to thereto, and various other opening/closing means can be applied. After pulling the air discharge port 22 forwardly using such an opening/closing means, if necessary, the user can replace the purification cartridge 40 embedded in the lower window stile 120 with a new one, thus allowing convenient replacement and management of the purification cartridge 30.

The light-transmission portion 23 is provided at the rear side of the lower window stile 120 such that light can arrive at the rear side of the purification cartridge 40. The light-transmission portion 23 is made of glass or transparent plastic materials, such as transparent acrylic. When light transmitted through the light-transmission portion 23 reaches the rear side of the purification cartridge 40, evaporation and removal of the moisture or the detrimental substances contained in the purification cartridge 40 occurs, thereby leading to enhanced endurance of the purification cartridge 40.

The outdoor air induction port 21 and the purified air discharge port 22 are respectively provided with filters, which are the same as those for the indoor air induction port 11 and the indoor air discharge port 12, as described above, and these filters are provided to prevent the fluid passageway 25 from being blocked by the insects or deleterious particles having a large volume contained in the outdoor air.

Similar to the plurality of skew plates 15 in the discharge passageway 14 formed along the inside of the upper guide member 13, a plurality of skew plates 26 are formed to the fluid passageway 25 formed along the inside of the upper guide member 24 for guiding air current along the serpentine path, thereby preventing outside noise from being transferred to the room.

Furthermore, a check valve 27 is provided to the fluid passageway 25 formed along the inside of the lower guide member 24 in order to prevent reverse flow of air, and can be easily formed using the same principle as that of the check valve 16 provided to the discharge passageway 14 formed along the inside of the upper guide member 13 as described above.

An air induction amount-regulating valve 29 is provided to the fluid passageway 25 formed along the inside of the lower guide member 24, and is configured such that opening thereof can be regulated in consideration of various conditions, such as climates or temperatures of the room and outside. As such, the amount of air induced into the room can be regulated by means of the air induction amount-regulating valve 29, thereby allowing easy control of indoor temperature together with control of ventilation.

The window stile 100 according to the present invention is provided with the indoor air circulation passageway 30, together with the discharge part 10 to discharge indoor air to the outside, and the induction part 20 to induce outdoor air inside while purifying outdoor air.

The indoor air circulation passageway 30 connects the indoor air induction port 11 and the purified air discharge port 22 such that some portion of air induced through the indoor air induction port 11 can be induced into the room after passing through the purification cartridge 40 and the purified air discharge port 22 along the indoor air circulation passageway 30.

More specifically, air induced through the indoor air induction port 11 passes through the check valve 16, and flows to a lower end of the side window stile 130 through the side window stile 130 along an outer surface of the upper guide member 13. Then, air within the lower end is purified through the purification cartridge 40 while flowing along an outer surface of the lower guide member 24, and purified air is induced into the room through the purified air discharge port 22. Thus, polluted air in the room can be automatically purified while circulating within the window stile 100 of the present invention in the course as described above, so that inhabitants can always inhale fresh and clean air.

According to the present invention, a dust discharge aperture 31 is formed at the rear side of the lower window stile 120 in order to discharge dust accumulated at a lower end of the purification cartridge 40 to the outside. When air is automatically or manually blown into the purification cartridge 40 through the purified air discharge port 22, the dust discharge aperture 31 serves to discharge dust accumulated at the lower end of the purification cartridge 40 together with air, which is discharged to the outside through the dust discharge aperture 31 while being prevented from being reversed to the outdoor air induction port 21 by means of the check valve 27.

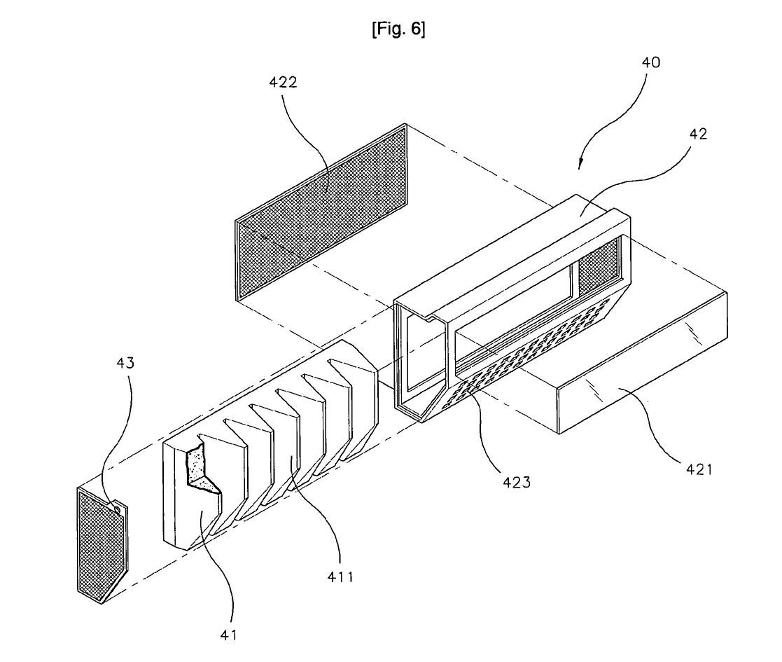

FIG. 6 is an exploded perspective view of the purification cartridge embedded in the window of the invention. As shown in FIG. 6, the purification cartridge 40, embedded in the window of the invention, comprises: a photocatalyst filter 41 having a plurality of protrusions 411 protruded to the outside at an upper portion of a rear side of the photocatalyst filter 41 and a plurality of inclined surfaces formed from a lower portion of the rear side of the photocatalyst filter 41 to the bottom of the photocatalyst filter 41, each of the protrusions 411 having activated carbon contained therein and a photocatalyst coated thereon; and a case 42 for enclosing the photocatalyst filter 41, and having a transparent window 421 at a rear side of the case, a plurality of induction holes 423 on an inclined surface at a lower portion of the rear side thereof, and a ventilation filter 422 at a front side thereof.

With the purification cartridge 40 having such a construction as described above embedded within the window stile 100 of the invention, when outdoor air passes through the photocatalyst filter 41 from the induction holes 423, the moisture or the detrimental substances contained in the outside air are adsorbed by the activated carbon in the photocatalyst filter 41, and at this time, the detrimental substances are decomposed and removed by virtue of decomposition reaction through oxidation-reduction of the photocatalyst.

As for the photocatalyst, commonly used substances, such as titanium oxide (TiO₂), can be applied to the present invention. In order to promote the decomposition reaction of the detrimental substances, the transparent window 421 is provided to the rear side of the purification cartridge 40. Furthermore, in order to allow light to freely arrive at the transparent window 421, the light-transmission portion 23 is formed at the rear side of the lower window stile 120.

That is, after sequentially passing through the light-transmission portion 23 and the transparent window 421, sunlight arrives at the photocatalyst filter 41 of the purification cartridge 40, activating the photocatalyst to decompose the detrimental substances. In the present invention, in order to promote decomposition by means of the photocatalyst, the plurality of protrusions 411 are protruded to the outside at the upper portion of the rear side of the photocatalyst filter 41.

At this time, a vent hole 43 is formed at an upper portion at one side of the purification cartridge 40, and a discharge hole 28 (see FIG. 3) communicated with the vent hole 43 is formed at the rear side of the purification cartridge 40, in order to discharge vapor gas generated from the moisture adsorbed into the purification cartridge 40 and decomposed gases generated from the detrimental substances to the outside.

Similar to the conventional windows, the window having the construction according to the present invention can be slidably equipped to the window frame 300. As shown in FIG. 5, the lower window stile 120 is formed at the lower end thereof with a guide groove 121, and the window frame 300 is formed with a guide 310 such that the guide groove 121 can cooperate with the guide 310, so that, with the window of the invention equipped to the window frame 300, the window can be slidably opened or closed to the left side or to the right side.

With the window of the present invention applied to buildings, it is possible not only to ventilate the room without opening the window, but also to induce outdoor air while purifying the outdoor air through the purification cartridge 40, thereby allowing fresh air to be induced into the room by means of natural ventilation. Furthermore, the polluted air within the room can be automatically purified while circulating in the window stile, thereby qualitatively enhancing the life and health of the inhabitants.

### INDUSTRIAL APPLICABILITY

As apparent from the above description, the automatic air purifying windows according to the present invention can sufficiently exhibit its inherent functions, thereby ensuring visibility from the living space, the provision of sufficient amount of sunlight exposure, thermal insulation, soundproofing, and the prevention of polluted substances from being induced from the outside. Additionally, with the automatic air purifying windows according to the invention, polluted air within the room can not only be automatically purified through re-circulation of the polluted air in the window stile, but also discharged to the outside while preventing polluted substance from being induced into the room by purifying outdoor air induced into the room, thereby maintaining freshness of air within the room.

It should be understood that the embodiments and the accompanying drawings as described above have been described for illustrative purposes and the present invention is limited by the following claims. Further, those skilled in the art will appreciate that various modifications, additions and substitutions are allowed without departing from the scope and spirit of the invention as set forth in the accompanying claims.

1. An automatic air purifying window, comprising a sheet of glass and a window stile for holding the sheet of glass, wherein the window stile comprises:
a discharge part including an indoor air induction port to induce indoor air through a filter attached to a front side of an upper window stile, an upper guide member to guide air current induced from the indoor air induction port, and an indoor air discharge port to discharge some portion of the indoor air induced from the indoor air induction port to the outside through a filter attached to an upper portion of a rear side of a side window stile along a discharge passageway formed inside the upper guide member;
an induction part including an outdoor air induction port to induce outdoor air through a filter attached to a lower portion of the rear side of the side window stile, a lower guide member to guide air current induced from the outdoor air induction port, a purification cartridge embedded at an inner portion of a lower window stile to purify air, flowing along a fluid passageway formed inside the lower guide member and passing through the purification cartridge, a light-transmission portion formed at a rear side of the lower window stile such that light can arrive at the purification cartridge within the lower window stile, and a purified air discharge port adapted to be opened/closed to the front of the lower window stile for allowing exchange of the purification cartridge and to allow the purified air passing through the purification cartridge to be induced into the room through a filter attached to the center of the purified air discharge port; and
an indoor air circulation passageway formed in the window stile such that some portion of air induced through the indoor air induction port can be induced into the room after passing through the purification cartridge and the purified air discharge port along the indoor air circulation passageway.

2. The window as set forth in claim 1, wherein the purification cartridge comprises:
a photocatalyst filter having a plurality of protrusions protruded to the outside at an upper portion of a rear side of the photocatalyst filter, and a plurality of inclined surfaces formed from a lower portion of the rear side of the photocatalyst filter to the bottom of the photocatalyst filter, each of the protrusions having activated carbon contained therein and a photocatalyst coated thereon; and
a case for enclosing the photocatalyst filter, and having a transparent window at a rear side of the case, a plurality of induction holes on an inclined surface at a lower portion of the rear side of the case, and a ventilation filter at a front side of the case.

3. The window as set forth in claim 1, further comprising:
a plurality of skew plates provided to the discharge passageway formed at the inside of the upper guide member, and to the fluid passageway formed at the inside of the lower guide member, respectively, for guiding the air current along a serpentine path; and
check valves provided to the discharge passageway formed at the inside of the upper guide member, and to the fluid passageway formed at the inside of the lower guide member, respectively, for preventing reverse flow of air.

4. The window as set forth in claim 3, further comprising a dust discharge aperture for discharging dust accumulated at a lower end of the purification cartridge to the outside.

5. The window as set forth in claim 4, further comprising: a vent hole formed at an upper portion at one side of the purification cartridge; and a discharge hole formed at the rear side of the purification cartridge to be communicated with the vent hole.

6. The window as set forth in claim 5, further comprising an air induction amount-regulating valve provided to the fluid passageway formed at the inside of the lower guide member for regulating an induced amount of air.

7. The window as set forth in claim 2, further comprising:
a plurality of skew plates provided to the discharge passageway formed at the inside of the upper guide member, and to the fluid passageway formed at the inside of the lower guide member, respectively, for guiding the air current along a serpentine path; and
check valves provided to the discharge passageway formed at the inside of the upper guide member, and to the fluid passageway formed at the inside of the lower guide member, respectively, for preventing reverse flow of air.
